(19) United States
(12) Patent Application Publication
(10) Pub. No.: US 2003/0219515 A1
(43) Pub. Date: Nov. 27, 2003

(54) Non-barrier food package

(76) Inventor: Guy L. Foulke JR., Hilton Head Island, SC (US)

Correspondence Address: Timothy N. Trop, TROP, PRUNER, & HU, P.C., Suite 100, 8554 Katy Freeway, Houston, TX, 77024-1841, US

(21) Appl. No.: 10/438,311

(22) Filed: May 14, 2003

Related U.S. Application Data
(60) Provisional application No. 60/380,814, filed on May 15, 2002.

(51) Int. Cl. C12C 1/027

(52) U.S. Cl. 426/106; 206/497

(57) ABSTRACT

A heat sealing device includes an insulated platen that protects heat sensitive lidding materials from sustaining heat damage. Generally, the platen is encased in an insulative material and houses an insulation plate within its perimeter. The insulative material and plate protect that portion of the lidding material that is external and internal to the seal area respectively. Thus, only that portion of the lidding material to be sealed to a tray is exposed to high temperatures.

This application claims the benefit of U.S. Provisional Application No. 60/380,814, filed May 15, 2002.

### BACKGROUND

This invention relates generally to packaging for food products and specifically to heat-sealed packaging for food products.

In retail food markets is common to see food products such as meat and poultry placed in a tray with a clear flexible material wrapped around the tray. This type of packaging however is prone to leakage. For example, liquid contents such as blood, juice or water may leak out of the package to soil the surrounding area.

Generally, the clear flexible lidding material used in this type of packaging is a type of polyethylene, which is relatively low cost. However, polyethylene is heat sensitive and is not typically heat sealed to a performed tray.

Other types of lidding material are available that withstand the heat-sealing process. However these types of lidding materials can be quite expensive.

Thus, there is a need for a way to heat seal a low cost lidding material to preformed trays.

### BRIEF DESCRIPTION OF THE DRAWINGS

FIG. 1 is a sectional partial of a package according to some embodiments of the present invention;

FIG. 2 is a sectional partial view of a heat sealing device according to some embodiments of the present invention; and

FIG. 3 is a sectional view of a heat sealing system that utilizes the heat sealing device of FIG. 2.

### DETAILED DESCRIPTION

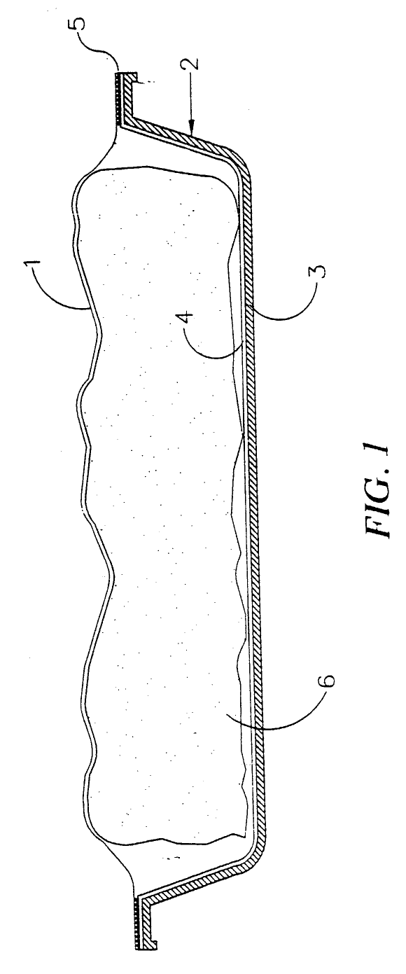

Referring to FIG. 1, a completed food package includes a food item 6 that is situated in a preformed tray 2 with lidding material 1 heat-sealed 5 thereto. The tray 2 may include a base 3 and a layer 4. The base 3 may be a conventional base made from materials such as plastic or paperboard. Likewise, the layer 4 may be made from a material such as polyethylene that coats or is laminated to the base 3. The food item 6 may be any food item including perishable foods such as meat or poultry.

According to some embodiments of the present invention, the lidding material 1 may be a sheet of thin flexible polyethylene. The polyethylene may be an unsupported polyethylene such as Clysar®, which is produced by DuPont Packaging and Industrial Polymers (Wilmington, Del.). Alternately, the polyethylene may be an irradiated polyethylene material available from SYFAN U.S.A. (9900 Stirling Road, Suite 302, Cooper City, Fla. 33024) or from Cryovac, a division of Sealed Air Corp. (Duncan, S.C.). The polyethylene material that forms the lidding 1 and the polyethylene material that forms the layer 4 are heat seal compatible.

Generally, the lidding material 1 is positioned over the tray 2 so that a portion of the material 1 comes in contact with a flange on the tray 2. Thereafter, a heat seal 5 is created between the lidding material 1 and the flange. The heat sealing of the lidding material 1 to the tray 2 is described in more detail below.

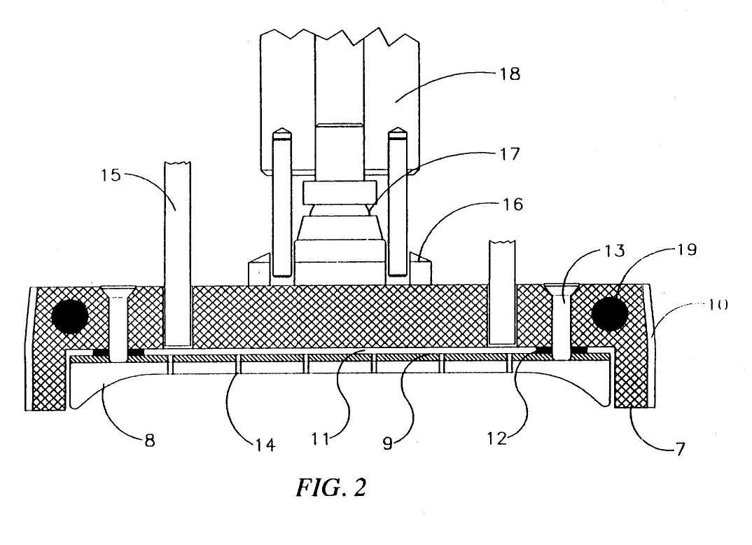

Referring to FIG. 2, in some embodiments of the present invention a heat sealing device may include a sealing platen 7, an insulator 10 and an insulation plate 8. The insulator 10 is attached to and encases the platen 7 whereas the insulation plate 8 is housed within the interior of the platen 7. One or more heating elements 19 such as an electric heating element are situated within the body of the platen 7. The heating element 19 heats the platen 7 in a conventional manner. Generally, the heating element 19 heats the platen 7 to a temperature that is high enough to seal the lidding material 1 to the tray 2. In some embodiments, the platen 7 may be coated with a non-stick material such as Teflon® (DuPont Teflon®, Barley Mill Plaza 10-2357, Wilmington, Del. 19880-0010).

The insulator 10 may be fabricated from a material such as high temperature silicon rubber, ceramic, syntactic foam or other insulating materials. Similarly, the plate 8 may also be fabricated from an insulating material such as high temperature silicon rubber, ceramic, syntactic foam or other insulating materials. Generally, the insulating properties of the insulator 10 and insulation plate 8 may prevent heat from damaging the susceptible heat sensitive lidding material 1.

The insulation plate 8 may have a contoured side and a non-contoured side that are opposed. The contoured side may complement the general shape of the food item that is being packaged. For example, in the case of packaging a cut of meat, the plate 8 may be concave to complement that portion of the meat that extends above the tray 2.

In some embodiments of the present invention, a carrier plate 9 may be utilized to couple the insulation plate 8 to the platen 7. For example, the insulation plate 8 may be vulcanized, glued or laminated to the carrier plate 9. Thereafter, a plurality of bolts 13 may attach the plates 8 and 9 to the platen 7. Generally, the bolts 13 extend downwardly through the platen 7 and the carrier plate 9 to attach the plates 8 and 9 to the platen 7.

In some embodiments, there may be a void area 11 between the platen 7 and the carrier plate 9. The void area 11 may be created by insulating spacers 12 that are disposed between the platen 7 and the carrier plate 9. Further, the bolts 13 may secure the spacers 12 between the platen 7 and the carrier plate 9.

The insulation plate 8 and carrier plate 9 may include air ventilation holes 14. The holes 14 may prevent air from becoming entrapped during heat-sealing. For examples, air that may otherwise be trapped between the plate 8 and the lidding 1 may pass through holes 14 to the void area 11.

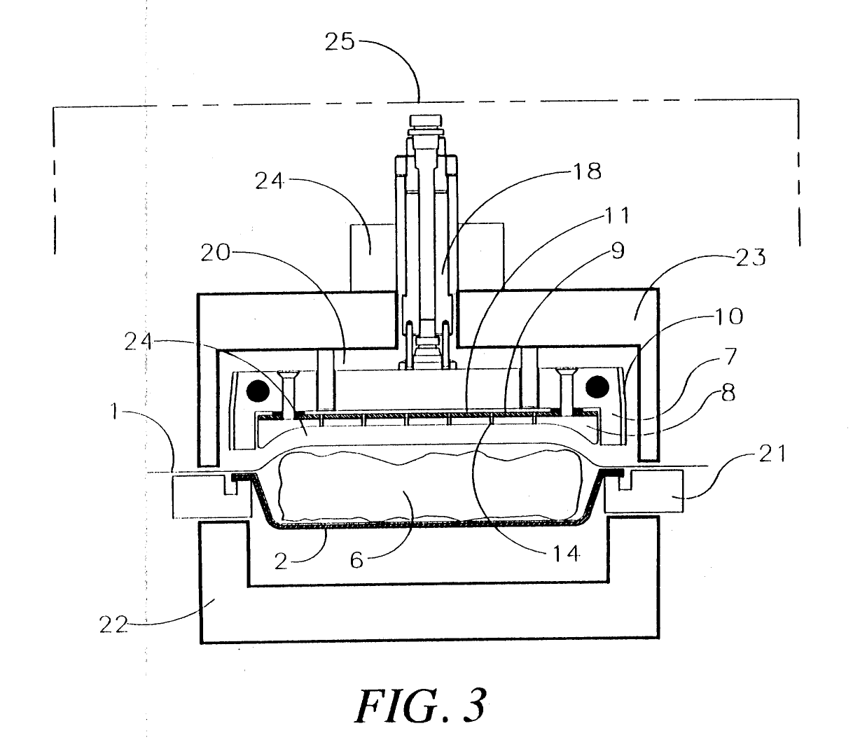

In some embodiments, a drive shaft 18 may be connected to an air cylinder 24 (FIG. 3) to drive the movement of the insulated platen 7. However, other embodiments may employ any suitable means for powering the movement of the shaft 18. In particular, the end of the drive shaft 18 that is proximate to the platen 7 is connected to a swivel or ball foot 17. The foot 17 is connected to a mounting block 16, which is connected to the top of the platen 7. In this way, the platen 7 may be lowered to contact the lidding material 1 during the heat-sealing process. Further, one or more guide shafts 15 may be utilized to position the platen 7 over the lidding 1 and tray 2.

Referring to FIG. 3, a sealing station 25 may include an upper 23 and a lower housing 22. The insulated platen 7 is situated within the upper housing 23. Generally, the sealing station 25 is part of a tray sealing machine (not shown). Examples of suitable tray sealing machines include World Class Packaging Machines', INPACK Packaging Systems (Ross Industries, Inc., 5321 Midland Road, Midland, Va. 22728) or Reiser's INPACK Tray Sealing System (Robert Reiser & Co. Inc., 725 Dedham St., Canton, Mass. 02021). However, some embodiments of the sealing device/sealing station 25 may be adapted for use in in-line Form/Fill/Seal machines.

Before creating a seal, a tray 2 filled with food product 6 is placed into a tray support carrier 21. The carrier 21 transports the tray 2 to a specific location within the sealing station 25. However, in some embodiments, the tray 2 may be delivered to the sealing station 25 by other means. While within the sealing station 25, the lidding material 1 is placed over the carrier 21. Typically, the lidding material 1 is of a width sufficient to cover the entire carrier 21. Transport of the lidding material 1 to the sealing station 25 may be by known means.

After the tray 2 and the lidding material 1 are properly positioned, the lower housing 22 is raised. Raising the housing 22 lifts the tray carrier 21 into contact with the upper housing 23 thereby clamping the lidding material 1 between the carrier 21 and the upper housing 23. The heated platen 7 may then be powered downward to have pressured contact with the lidding material 1 thereby creating a heat seal 5 between the lidding material 1 and the flange on the tray 2.

The insulator 10 that surrounds the platen 7 protects that portion of the heat sensitive lidding material 1 external to the seal 5 from the elevated temperature of the platen 7. For example, the insulator 10 may protect the lidding material 1 between the housing 23 and the platen 7. Likewise, the insulation plate 8 protects that portion of the lidding material 1 that is internal to the seal 5. For example, the plate 8 protects the lidding material 1 over the food product 6 from heat produced by the platen 7.

Air trapped between the insulation plate 8 and the lidding material 1 may have a negative effect on the quality of the seal 5. Thus, the air ventilation holes 14 through the plates 8 and 9 have been provided to allow for the escape of air into the void area 11.

After the lidding material 1 is sealed to the tray 2, the heated platen 7 is raised to its original position and the lower housing 22 is retracted. In some embodiments, when the lower housing 22 is retracted, the tray carrier 21 may be lowered as well. Thereafter, the tray 2 containing the sealed in food product 6 may be transported to the next station in the packaging machine. In some embodiments the next station that the carrier 21 visits includes a lidding severing device (not shown) that cuts the lidding around the periphery of the tray 2. In other embodiments, the lidding severing device may be within the sealing station, which is known as “cut in place”.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A heat sealing device comprising:
a platen;
an insulator encasing said plate; and
an insulating plate housed within the interior of said platen.
